(19) United States
(12) Patent Application Publication
(10) Pub. No.: US 2008/0319081 A1
(43) Pub. Date: Dec. 25, 2008

(54) Insecticidal Compositions Having Improved Effect

(75) Inventors: Rudiger Fischer, Pulheim (DE); Reiner Fischer, Monheim (DE); Christian Funke, Leichlingen (DE); Rolf Pontzen, Leichlingen (DE); Udo Reckmann, Koln (DE); Peter Marczok, Koln (DE); Christain Arnold, Langenfeld (DE); Erich Sanwald, Kiel (DE); Waltraud Hempel, Liederbach (DE)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(73) Assignee: Bayer CropScience Ag, Monheim (DE)

(21) Appl. No.: 12/096,179

(22) PCT Filed: Nov. 30, 2006
(86) PCT No.: PCT/EP2006/011473

§ 371 Date: Sep. 8, 2008

(30) Foreign Application Priority Data
Dec. 13, 2005 (DE) 102005059466.2

(51) Int. Cl. A01N 37/18

(52) U.S. Cl. 514/616

(57) ABSTRACT

The present invention relates to increasing the activity of crop protection compositions comprising phthalic acid diamides through the addition of ammonium salts and/or phosphonium salts or through the addition of ammonium or phosphonium salts and penetrants, to the corresponding compositions, to processes for preparing them and to their use in crop protection.

The present invention relates to increasing the activity of crop protection compositions comprising phthalic acid diamides through the addition of ammonium salts and/or phosphonium salts or through the addition of ammonium or phosphonium salts and penetrants, to the corresponding compositions, to processes for preparing them and to their use in crop protection.

Phthalic acid diamides are known as compounds having insecticidal properties (cf. EP-A-0 919 542, EP-A-1 006 107, WO 01/00 575, WO 01/00 599, WO 01/46 124, JP-A 2001-33 555 9, WO 01/02354, WO 01/21 576, WO 02/08 8074, WO 02/08 8075, WO 02/09 4765, WO 02/09 4766, WO 02/06 2807).

Such phthalic acid diamides are described by the formula (I):

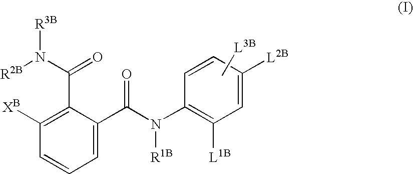

in which
X^{B} represents halogen, cyano, C₁-C₈-alkyl, C₁-C₈-haloalkyl, C₁-C₈-alkoxy or C₁-C₈-haloalkoxy,
R^{1B}, R^{2B} and R^{3B} independently of one another represent hydrogen, cyano, represent optionally halogen-substituted C₃-C₈-cycloalkyl or represent the group —M^{1B}-Q^{B}ₖ,
M^{1B} represents optionally substituted achiral C₁-C₁₂-alkylene, achiral C₃-C₁₂-alkenylene or achiral C₃-C₁₂-alkynylene,
Q^{B} represents hydrogen, halogen, cyano, nitro, C₁-C₈-haloalkyl, in each case optionally substituted C₃-C₈-cycloalkyl, C₁-C₈-alkyl-carbonyl or C₁-C₈-alkoxy-carbonyl, in each case optionally substituted phenyl, hetaryl or represents the group -T^{B}-R^{4B},
T^{B} represents oxygen, —S(O)ₘ— or —N(R^{5B})—,
R^{4B} represents hydrogen, in each case optionally substituted C₁-C₁₂-alkyl, C₃-C₁₂-alkenyl, C₃-C₁₂-alkynyl, C₃-C₈-cycloalkyl, C₃-C₈-cycloalkyl-C₁-C₆-alkyl, C₁-C₆-alkoxy-C₁-C₄-alkyl, C₁-C₈-alkyl-carbonyl, C₁-C₈-alkoxy-carbonyl, phenyl, phenyl-C₁-C₄-alkyl, phenyl-C₁-C₄-alkoxy, hetaryl, hetaryl-C₁-C₄-alkyl,
R^{5B} represents hydrogen, represents in each case optionally substituted C₁-C₈-alkyl-carbonyl, C₁-C₈-alkoxy-carbonyl, phenylcarbonyl or phenyl-C₁-C₆-alkoxy-carbonyl,
k represents 1, 2, 3, or 4,
m represents 0, 1 or 2,
R^{1B} and R^{2B} together form an optionally substituted 4- to 7-membered ring which may optionally be interrupted by heteroatoms,
L^{1B} and L^{3B} independently of one another represent hydrogen, halogen, cyano or in each case optionally substituted C₁-C₈-alkyl, C₁-C₈-alkoxy, C₁-C₆-alkyl-S(O)ₘ—, phenyl, phenoxy or hetaryloxy,
L^{2B} represents hydrogen, halogen, cyano, in each case optionally substituted C₁-C₁₂-alkyl, C₂-C₁₂-alkenyl, C₂-C₁₂-alkynyl, C₁-C₁₂-haloalkyl, C₃-C₈-cycloalkyl, phenyl, hetaryl or represents the group -M^{2B}-R^{6B},
M^{2B} represents oxygen or —S(O)ₘ—,
R^{6B} represents in each case optionally substituted C₁-C₈-alkyl, C₂-C₈-alkenyl, C₃-C₆-alkynyl, C₃-C₈-cycloalkyl, phenyl or hetaryl,
L^{1B} and L^{3B} or L^{1B} and L^{2B} in each case together form an optionally substituted 5- or 6-membered ring which may optionally be interrupted by heteroatoms.

The formula (I) provides a general definition of the phthalic acid diamides of the acaricidal and/or insecticidal compositions. Preferred substituents or ranges of radicals listed in the formulae mentioned above and below are illustrated below:
X^{B} preferably represents fluorine, chlorine, bromine, iodine, cyano, C₁-C₆-alkyl, C₁-C₆-halo-alkyl, C₁-C₆-alkoxy or C₁-C₆-haloalkoxy.
R^{1B}, R^{2B} and R^{3B} independently of one another preferably represent hydrogen, cyano, represent optionally halogen-substituted C₃-C₆-cycloalkyl or represent the group -M^{1B}-Q^{B}ₖ.
M^{1B} preferably represents achiral C₁-C₈-alkylene, achiral C₃-C₆-alkenylene or achiral C₃-C₆-alkynylene.
Q^{B} preferably represents hydrogen, halogen, cyano, nitro, C₁-C₆-haloalkyl or represents optionally fluorine, chlorine, C₁-C₆-alkyl or C₁-C₆-alkoxy-substituted C₃-C₈-cycloalkyl in which optionally one or two not directly adjacent ring members are replaced by oxygen and/or sulphur or represents in each case optionally halogen-substituted C₁-C₆-alkyl-carbonyl or C₁-C₆-alkoxy-carbonyl or represents in each case optionally halogen-, C₁-C₆-alkyl-, C₁-C₆-haloalkyl-, C₁-C₆-alkoxy-, C₁-C₆-haloalkoxy-, cyano- or nitro-substituted phenyl or hetaryl having 5 or 6 ring atoms (for example furanyl, pyridyl, imidazolyl, triazolyl, pyrazolyl, pyrimidyl, thiazolyl or thienyl) or represents the group -T^{B}-R^{4B}.
T^{B} preferably represents oxygen, —S(O)ₘ— or —N(R^{5B})—.
R^{4B} preferably represents hydrogen, represents in each case optionally fluorine- and/or chlorine-substituted C₁-C₈-alkyl, C₃-C₈-alkenyl, C₃-C₈-alkynyl, C₃-C₈-cycloalkyl, C₃-C₈-cycloalkyl-C₁-C₂-alkyl, C₁-C₆-alkyl-carbonyl, C₁-C₆-alkoxy-carbonyl, represents phenyl, phenyl-C₁-C₄-alkyl, phenyl-C₁-C₄-alkoxy, hetaryl or hetaryl-C₁-C₄-alkyl, each of which is optionally mono- to tetra-substituted by halogen, C₁-C₆-alkyl, C₁-C₆-alkoxy, C₁-C₄-haloalkyl, C₁-C₄-haloalkoxy, nitro or cyano, where hetaryl has 5 or 6 ring atoms (for example furanyl, pyridyl, imidazolyl, triazolyl, pyrazolyl, pyrimidyl, thiazolyl or thienyl).
R^{5B} preferably represents hydrogen, represents in each case optionally fluorine- and/or chlorine-substituted C₁-C₆-alkyl-carbonyl, C₁-C₆-alkoxy-carbonyl, represents phenylcarbonyl or phenyl-C₁-C₄-alkyloxy-carbonyl, each of which is optionally mono to tetrasubstituted by halogen, C₁-C₆-alkyl, C₁-C₆-alkoxy, C₁-C₄-haloalkyl, C₁-C₄-haloalkoxy, nitro or cyano.
k preferably represents 1, 2 or 3.
m preferably represents 0, 1 or 2.
R^{1B} and R^{2B} together preferably form a 5- or 6-membered ring which may optionally be interrupted by an oxygen or sulphur atom.
L^{1B} and L^{3B} independently of one another preferably represent hydrogen, cyano, fluorine, chlorine, bromine, iodine, C₁-C₆-alkyl, C₁-C₄-haloalkyl, C₁-C₆-alkoxy, C₁-C₄-haloalkoxy, C₁-C₄-alkyl-S(O)ₘ—, C₁-C₄-haloalkyl-S(O)ₘ—, represent phenyl, phenoxy, pyridinyloxy, thiazolyloxy or pyrimidinyloxy, each of which is optionally mono- to trisubstituted by fluorine, chlorine, bromine, C₁-C₆-alkyl, C₁-C₆-alkoxy, C₁-C₄-haloalkyl, C₁-C₄-haloalkoxy, cyano or nitro.
L^{2B} preferably represents hydrogen, fluorine, chlorine, bromine, iodine, cyano, represents in each case optionally fluorine- and/or chlorine-substituted C₁-C₁₀-alkyl, C₂-C₁₀-alkenyl, C₂-C₆-alkynyl, represents in each case optionally fluorine-, chlorine-substituted C₃-C₆-cycloalkyl, represents phenyl, pyridinyl, thienyl, pyrimidyl or thiazolyl, each of which is optionally mono- to trisubstituted by fluorine, chlorine, bromine, C₁-C₆-alkyl, C₁-C₆-alkoxy, C₁-C₄-haloalkyl, C₁-C₄-haloalkoxy, cyano or nitro, or represents the group -M^{2B}-R^{6B}.
M^{2B} preferably represents oxygen or —S(O)ₘ—.
R^{6B} preferably represents in each case optionally fluorine- and/or chlorine-substituted C₁-C₈-alkyl, C₂-C₈-alkenyl, C₃-C₆-alkynyl or C₃-C₆-cycloalkyl, represents phenyl, pyridyl, pyrimidinyl or thiazolyl, each of which is optionally mono- to trisubstituted by fluorine, chlorine, bromine, C₁-C₆-alkyl, C₁-C₆-alkoxy, C₁-C₄-haloalkyl, C₁-C₄-haloalkoxy, cyano or nitro.
L^{1B} and L^{3B} or L^{1B} and L^{2B} in each case together preferably form a 5- or 6-membered ring which is optionally substituted by fluorine and/or C₁-C₂-alkyl and which may optionally be interrupted by one or two oxygen atoms.
X^{B} particularly preferably represents chlorine, bromine or iodine.
R^{1B}, R^{2B} and R^{3B} independently of one another particularly preferably represent hydrogen or represent the group -M^{1B}-Q^{B}ₖ.
M^{1B} particularly preferably represents achiral C₁-C₈-alkylene, achiral C₃-C₆-alkenylene or achiral C₃-C₆-alkynylene.
Q^{B} particularly preferably represents hydrogen, fluorine, chlorine, cyano, trifluoromethyl, C₃-C₆-cycloalkyl or represents the group -T^{B}-R^{4B}.
T^{B} particularly preferably represents oxygen or —S(O)ₘ—.
R^{4B} particularly preferably represents hydrogen, represents C₁-C₆-alkyl, C₃-C₆-alkenyl, C₃-C₆-alkynyl or C₃-C₆-cycloalkyl, each of which is optionally mono- to trisubstituted by fluorine and/or chlorine.
k particularly preferably represents 1, 2 or 3.
m particularly preferably represents 0, 1 or 2.
L^{1B} and L^{3B} independently of one another particularly preferably represent hydrogen, fluorine, chlorine, bromine, iodine, cyano, C₁-C₄-alkyl, C₁-C₂-haloalkyl, C₁-C₄-alkoxy, C₁-C₂-haloalkoxy, represent phenyl or phenoxy, each of which is optionally mono- or disubstituted by fluorine, chlorine, bromine, C₁-C₄-alkyl, C₁-C₄-alkoxy, C₁-C₂-haloalkyl, C₁-C₂-haloalkoxy, cyano or nitro.
L^{2B} particularly preferably represents hydrogen, fluorine, chlorine, bromine, iodine, cyano, represents C₁-C₆-alkyl, C₂-C₆-alkenyl, C₂-C₆-alkynyl, C₃-C₆-cycloalkyl, each of which is optionally mono- to tridecasubstituted by fluorine and/or chlorine, or represents the group -M^{2B}-R^{6B}.
M^{2B} particularly preferably represents oxygen or —S(O)ₘ—.
R^{6B} particularly preferably represents C₁-C₆-alkyl, C₂-C₆-alkenyl, C₂-C₆-alkynyl or C₃-C₆-cycloalkyl, each of which is optionally mono- to tridecasubstituted by fluorine and/or chlorine, represents phenyl or pyridyl, each of which is optionally mono- or disubstituted by fluorine, chlorine, bromine, C₁-C₄-alkyl, C₁-C₄-alkoxy, trifluoromethyl, difluoromethoxy, trifluoromethoxy, cyano or nitro.
X^{B} very particularly preferably represents iodine.
R^{1B} and R^{2B} very particularly preferably represent hydrogen.
R^{3B} very particularly preferably represents the group -M^{1B}-Q^{B}.
M^{1B} very particularly preferably represents-C(CH₃)₂CH₂— or —C(C₂H₅)₂CH₂—.
Q^{B} very particularly preferably represents hydrogen, fluorine, chlorine, cyano, trifluoromethyl, C₃-C₆-cycloalkyl or represents the group -T^{B}-R^{4B}.
T^{B} very particularly preferably represents-S—, —SO— or —SO₂—.
R^{4B} very particularly preferably represents methyl, ethyl, n-propyl, isopropyl, n-butyl, isobutyl, sec-butyl or tert-butyl, allyl, butenyl or isoprenyl, each of which is optionally mono- to trisubstituted by fluorine and/or chlorine.
L^{1B} and L^{3B} independently of one another very particularly preferably represent hydrogen, fluorine, chlorine, bromine, iodine, cyano, methyl, ethyl, n-propyl, isopropyl, tert-butyl, methoxy, ethoxy, trifluoromethyl, difluoromethoxy or trifluoromethoxy.
L^{2B} very particularly preferably represents hydrogen, fluorine, chlorine, bromine, iodine, cyano, represents methyl, ethyl, n-propyl, isopropyl, n-butyl, isobutyl, sec-butyl, tert-butyl, allyl, butenyl or isoprenyl, each of which is optionally mono- to nonasubstituted by fluorine and/or chlorine, or represents the group -M^{2B}-R^{6B}.
M^{2B} very particularly preferably represents oxygen or sulphur.
R^{6B} very particularly preferably represents methyl, ethyl, n-propyl, isopropyl, n-butyl, isobutyl, sec-butyl, tert-butyl, allyl, butenyl or isoprenyl, each of which is optionally mono- to nonasubstituted by fluorine and/or chlorine, represents phenyl which is optionally mono- or disubstituted by fluorine, chlorine, bromine, methyl, ethyl, methoxy, trifluoromethyl, difluoromethoxy, trifluoromethoxy, cyano or nitro.

Specifically, particular mention may be made of the following compounds of the formula (I):

TABLE 1

| | |
|---|---|
| | (I) |
| 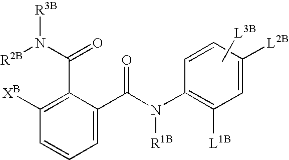 | |

| No. | X^{B} | R^{1B} | R^{2B} | R^{3B} | L^{1B} | L^{2B} | L^{3B} |
|---|---|---|---|---|---|---|---|
| I-1 | I | H | H | —C(CH₃)₂CH₂SCH₃ | CH₃ | iso- | H |
| | | | | | | C₃F₇ | |
| 1-2 | I | H | H | —C(CH₃)₂CH₂SOCH₃ | CH₃ | iso- | H |
| | | | | | | C₃F₇ | |
| 1-3 | I | H | H | —C(CH₃)₂CH₂SO₂CH₃ | CH₃ | iso- | H |
| | | | | | | C₃F₇ | |

The activity of these compounds is good; however, in some cases it is nevertheless unsatisfactory.

All compounds according to the invention are already known as agents for controlling animal pests, in particular insects, and can be prepared by processes described in the prior art. The activity of these compounds is good; however, in particular at low application rates and concentrations, it is not always entirely satisfactory. There is therefore a need for increasing the activity of the crop protection compositions comprising the compounds.

In the compositions according to the invention, the active compounds can be employed in a broad range of concentrations. The concentration of the active compounds in the formulation is usually 0.1-50% by weight.

Descriptions have already been given in the literature to the effect that the activity of various active compounds can be increased through addition of ammonium or phosphonium salts. The salts in question, however, are salts with a detergent effect (for example WO 95/017817) and/or salts having relatively long alkyl and/or aryl substituents, which have a permeabilizing effect or which increase the solubility of the active compound (for example EP-A 0 453 086, EP-A 0 664 081, FR-A 2 600 494, U.S. Pat. No. 4,844,734, U.S. Pat. No. 5,462,912, U.S. Pat. No. 5,538,937, Ser. No. 03/0224939, Ser. No. 05/0009880, Ser. No. 05/0096386). Furthermore, the prior art describes the activity only for certain active compounds and/or certain applications of the composition in question. In still other cases, they are salts of sulphonic acids where the acids for their part have a paralysing action on insects (U.S. Pat. No. 2,842,476). An activity increase through ammonium sulphate is described for the herbicides glyphosate and phosphinothricin (U.S. Pat. No. 6,645,914, EP-A 0 036 106). However, this prior art neither discloses nor suggests a corresponding activity for insecticides.

Also, the use of ammonium sulphate as a formulating auxiliary has been described for certain active compounds and applications (WO 92/16108), but it is used there for the purpose of stabilizing the formulation, not for increasing activity.

It has now been found, entirely surprisingly, that the activity of insecticides from the class of the phthalic acid diamides can be increased significantly through the addition of ammonium salts and/or phosphonium salts to the as-used solution (tank mix application) or through the incorporation of these salts into a formulation comprising such insecticides. Accordingly, the present invention provides the use of ammonium salts and/or phosphonium salts for increasing the activity of crop protection compositions comprising insecticidally active inhibitors of the nicotinic acetylcholine receptor as active compound. The invention also provides compositions comprising such insecticides and activity-increasing ammonium salts and/or phosphonium salts, specifically including not only formulated active compounds but also ready-to-use compositions (spray liquors). Finally, the invention also provides the use of these compositions for controlling harmful insects.

Ammonium salts and phosphonium salts which, according to the invention, increase the activity of crop protection compositions comprising phthalic acid diamides are defined by formula (II)

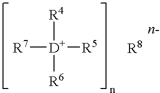

in which
D represents nitrogen or phosphorus,
D preferably represents nitrogen,
R⁴, R⁵, R⁶ and R⁷ independently of one another represent hydrogen or in each case optionally substituted C₁-C₈-alkyl or mono- or polyunsaturated, optionally substituted C₁-C₈-alkylene, where the substituents may be selected from the group consisting of halogen, nitro and cyano,
R⁴, R⁵, R⁶ and R⁷ preferably independently of one another represent hydrogen or in each case optionally substituted C₁-C₄-alkyl, where the substituents may be selected from the group consisting of halogen, nitro and cyano,
R⁴, R⁵, R⁶ and R⁷ particularly preferably independently of one another represent hydrogen, methyl, ethyl, n-propyl, isopropyl, n-butyl, isobutyl, s-butyl or t-butyl,
R⁴, R⁵, R⁶ and R⁷ very particularly preferably represent hydrogen,
R⁴, R⁵, R⁶ and R⁷ furthermore very particularly preferably both represent methyl or both represent ethyl,
n represents 1, 2, 3 or 4,
n preferably represents 1 or 2,
R⁸ represents an inorganic or organic anion,
R⁸ preferably represents bicarbonate, tetraborate, fluoride, bromide, iodide, chloride, monohydrogenphosphate, dihydrogenphosphate, hydrogensulphate, tartrate, sulphate, nitrate, thiosulphate, thiocyanate, formate, lactate, acetate, propionate, butyrate, pentanoate, citrate or oxalate,
R⁸ furthermore preferably represents carbonate, pentaborate, sulphite, benzoate, hydrogenoxalate, hydrogencitrate, methylsulphate or tetrafluoroborate,
R⁸ particularly preferably represents lactate, sulphate, nitrate, thiosulphate, thiocyanate, citrate, oxalate or formate,
R⁸ furthermore particularly preferably represents monohydrogenphosphate or dihydrogenphosphate and
R⁸ very particularly preferably represents sulphate.

The ammonium salts and phosphonium salts of the formula (II) can be used in a broad concentration range to increase the activity of crop protection compositions comprising anthranilamides. In general, the ammonium salts or phosphonium salts are used in the ready-to-use crop protection composition in a concentration of from 0.5 to 80 mmol/l, preferably from 0.75 to 37.5 mmol/l, particularly preferably from 1.5 to 25 mmol/l. In the case of a formulated product, the ammonium salt concentration and/or phosphonium salt concentration in the formulation is chosen such that it is within these stated general, preferred or very preferred ranges after the formulation has been diluted to the desired active compound concentration. The concentration of the salt in the formulation here is typically 1-50% by weight.

In a preferred embodiment of the invention, the activity is increased by adding to the crop protection compositions not only an ammonium salt and/or phosphonium salt but also, additionally, a penetrant. It is considered entirely surprising that even in these cases an even greater activity increase is observed. The present invention therefore likewise provides the use of a combination of penetrant and ammonium salts and/or phosphonium salts for increasing the activity of crop protection compositions comprising insecticidally active inhibitors of the nicotinic acetylcholine receptor as active compound. The invention likewise provides compositions which comprise insecticidally active inhibitors of the nicotinic acetylcholine receptor, penetrants and ammonium salts and/or phosphonium salts, including specifically not only formulated active compounds but also ready-to-use compositions (spray liquors). The invention additionally provides, finally, for the use of these compositions for controlling harmful insects.

Suitable penetrants in the present context include all those substances which are typically used to enhance the penetration of agrochemically active compounds into plants. Penetrants are defined in this context by their ability to penetrate from the aqueous spray liquor and/or from the spray coating into the cuticle of the plant and thereby to increase the mobility of active compounds in the cuticle. The method described in the literature (Baur et al., 1997, Pesticide Science 51, 131-152) can be used in order to determine this property.

Suitable penetrants are, for example, alkanol alkoxylates. Penetrants according to the invention are alkanol alkoxylates of the formula

R—O-(-AO)ᵥ—R′ (III)

in which
R represents straight-chain or branched alkyl having 4 to 20 carbon atoms,
R′ represents hydrogen, methyl, ethyl, n-propyl, isopropyl, n-butyl, isobutyl, t-butyl, n-pentyl or n-hexyl,
AO represents an ethylene oxide radical, a propylene oxide radical, a butylene oxide radical or represents mixtures of ethylene oxide and propylene oxide radicals or butylene oxide radicals and
v represents numbers from 2 to 30.

A preferred group of penetrants are alkanol alkoxylates of the formula

R—O-(-EO—)ₙ—R′ (III-a)

in which
R is as defined above,
R′ is as defined above,
EO represents —CH₂—CH₂—O— and
n represents numbers from 2 to 20.

A further preferred group of penetrants are alkanol alkoxylates of the formula

R—O-(-EO—)ₚ—(—PO—)_{q}—R′ (III-b)

in which
R is as defined above,
R′ is as defined above,
EO represents —CH₂—CH₂—O—,
PO represents

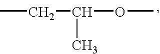

p represents numbers from 1 to 10 and
q represents numbers from 1 to 10.

A further preferred group of penetrants are alkanol alkoxylates of the formula

R—O—(—PO—)ᵣ-(EO—)ₛ—R (III-c)

in which
R is as defined above,
R′ is as defined above,
EO represents —CH₂—CH₂—O—,
PO represents

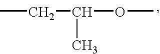

r represents numbers from 1 to 10 and
s represents numbers from 1 to 10.

A further preferred group of penetrants are alkanol alkoxylates of the formula

R—O-(-EO—)ₚ—(—BO—)_{q}—R′ (III-d)

in which
R and R′ are as defined above,
EO represents CH₂—CH₂—O—,
BO represents

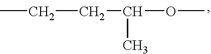

p represents numbers from 1 to 10 and
q represents numbers from 1 to 10.

A further preferred group of penetrants are alkanol alkoxylates of the formula

R—O—(—BO—)ᵣ-(-EO—)ₛ—R′ (III-e)

in which
R and R′ are as defined above,
BO represents

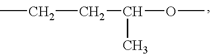

EO represents CH₂—CH₂—O—,
r represents numbers from 1 to 10 and
s represents numbers from 1 to 10.

A further preferred group of penetrants are alkanol alkoxylates of the formula

CH₃—(CH₂)ₜ—CH₂—O—(—CH₂—CH₂—O—)ᵤ—R′ (III-f)

in which
R′ is as defined above,
t represents numbers from 8 to 13 and
u represents numbers from 6 to 17.

In the formulae given above,
R preferably represents butyl, isobutyl, n-pentyl, isopentyl, neopentyl, n-hexyl, isohexyl, n-octyl, isooctyl, 2-ethylhexyl, nonyl, isononyl, decyl, n-dodecyl, isododecyl, lauryl, myristyl, isotridecyl, trimethylnonyl, palmityl, stearyl or eicosyl.

An example which may be mentioned of an alkanol alkoxylate of the formula (III-c) is 2-ethyl-hexyl alkoxylate of the formula

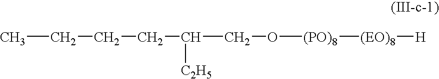

in which
EO represents —CH₂—CH₂—O—,
PO represents

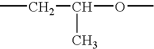

and the numbers 8 and 6 are average values.

An example which may be mentioned of an alkanol alkoxylate of the formula (III-d) is the formula

CH₃—(CH₂)₁₀—O-(-EO—)₆—(—BO—)₂—CH₃ (III-d-1)

in which
EO represents CH₂—CH₂—O—,
BO represents and

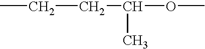

the numbers 10, 6 and 2 are average values.

Particularly preferred alkanol alkoxylates of the formula (III-f) are compounds of this formula in which
t represents numbers from 9 to 12 and
u represents numbers from 7 to 9.

The alkanol alkoxylate of the formula (III-f-1)

CH₃—(CH₂)ₜ—CH₂—O—(—CH₂—CH₂—O—)ᵤ—H (III-f-1)

in which
t represents the average value 10.5 and
u represents the average value 8.4
   may be mentioned as being very particularly preferred.

The above formulae provide a general definition of the alkanol alkoxylates. These substances are mixtures of substances of the stated type with different chain lengths. The indices therefore have average values which may also deviate from whole numbers.

The alkanol alkoxylates of the formulae stated are known and in some cases are available commercially or can be prepared by known methods (cf. WO 98-35 553, WO 00-35 278 and EP-A 0 681 865).

Suitable penetrants also include, for example, substances which promote the solubility of the compounds of the formula (I) in a spray coating. These include, for example, mineral and vegetable oils. Suitable oils are all mineral or vegetable oils—modified or otherwise—which can typically be used in agrochemical compositions. Mention may be made by way of example of sunflower oil, rapeseed oil, olive oil, castor oil, colza oil, maizeseed oil, cottonseed oil and soybean oil, or the esters of said oils. Preference is given to rapeseed oil, sunflower oil and their methyl or ethyl esters.

The concentration of penetrants in the compositions according to the invention can be varied within a wide range. In the case of a formulated crop protection composition, it is generally from 1 to 95% by weight, preferably from 1 to 55% by weight, particularly preferably from 15 to 40% by weight. In the ready-to-use compositions (spray liquors), the concentration is generally between 0.1 and 10 g/l, preferably between 0.5 and 5 g/l.

Inventively emphasized combinations of active compound, salt and penetrant are listed in the table below. Here, “as per test” means that any compound that acts as a penetrant in the cuticle penetration test (Baur et al., 1997, Pesticide Science 51, 131-152) is suitable.

| | Active | | |
|---|---|---|---|
| # | compound | Salt | Penetrant |
| 1 | (I-1) | ammonium sulphate | as per test |
| 2 | (I-1) | ammonium lactate | as per test |
| 3 | (I-1) | ammonium nitrate | as per test |
| 4 | (I-1) | ammonium thiosulphate | as per test |
| 5 | (I-1) | ammonium thiocyanate | as per test |
| 6 | (I-1) | ammonium citrate | as per test |
| 7 | (I-1) | ammonium oxalate | as per test |
| 8 | (I-1) | ammonium formate | as per test |
| 9 | (I-1) | ammonium hydrogenphosphate | as per test |
| 10 | (I-1) | ammonium dihydrogenphosphate | as per test |
| 11 | (I-1) | ammonium carbonate | as per test |
| 12 | (I-1) | ammonium benzoate | as per test |
| 13 | (I-1) | ammonium sulphite | as per test |
| 14 | (I-1) | ammonium benzoate | as per test |
| 15 | (I-1) | ammonium hydrogenoxalate | as per test |
| 16 | (I-1) | ammonium hydrogencitrate | as per test |
| 17 | (I-1) | ammonium acetate | as per test |
| 18 | (I-1) | tetramethylammonium sulphate | as per test |
| 19 | (I-1) | tetramethylammonium lactate | as per test |
| 20 | (I-1) | tetramethylammonium nitrate | as per test |
| 21 | (I-1) | tetramethylammonium thiosulphate | as per test |
| 22 | (I-1) | tetramethylammonium thiocyanate | as per test |
| 23 | (I-1) | tetramethylammonium citrate | as per test |
| 24 | (I-1) | tetramethylammonium oxalate | as per test |
| 25 | (I-1) | tetramethylammonium formate | as per test |
| 26 | (I-1) | tetramethylammonium | as per test |
| | | hydrogenphosphate | |
| 27 | (I-1) | tetramethylammonium | as per test |
| | | dihydrogenphosphate | |
| 28 | (I-1) | tetraethylammonium sulphate | as per test |
| 29 | (I-1) | tetraethylammonium lactate | as per test |
| 30 | (I-1) | tetraethylammonium nitrate | as per test |
| 31 | (I-1) | tetraethylammonium thiosulphate | as per test |
| 32 | (I-1) | tetraethylammonium thiocyanate | as per test |
| 33 | (I-1) | tetraethylammonium citrate | as per test |
| 34 | (I-1) | tetraethylammonium oxalate | as per test |
| 35 | (I-1) | tetraethylammonium formate | as per test |
| 36 | (I-1) | tetraethylammonium | as per test |
| | | hydrogenphosphate | |
| 37 | (I-1) | tetraethylammonium | as per test |
| | | dihydrogenphosphate | |
| 38 | (I-2) | ammonium sulphate | as per test |
| 39 | (I-2) | ammonium lactate | as per test |
| 40 | (I-2) | ammonium nitrate | as per test |
| 41 | (I-2) | ammonium thiosulphate | as per test |
| 42 | (I-2) | ammonium thiocyanate | as per test |
| 43 | (I-2) | ammonium citrate | as per test |
| 44 | (I-2) | ammonium oxalate | as per test |
| 45 | (I-2) | ammonium formate | as per test |
| 46 | (I-2) | ammonium hydrogenphosphate | as per test |
| 47 | (I-2) | ammonium dihydrogenphosphate | as per test |
| 48 | (I-2) | ammonium carbonate | as per test |
| 49 | (I-2) | ammonium benzoate | as per test |
| 50 | (I-2) | ammonium sulphite | as per test |
| 51 | (I-2) | ammonium benzoate | as per test |
| 52 | (I-2) | ammonium hydrogenoxalate | as per test |
| 53 | (I-2) | ammonium hydrogencitrate | as per test |
| 54 | (I-2) | ammonium acetate | as per test |
| 55 | (I-2) | tetramethylammonium sulphate | as per test |
| 56 | (I-2) | tetramethylammonium lactate | as per test |
| 57 | (I-2) | tetramethylammonium nitrate | as per test |
| 58 | (I-2) | tetramethylammonium thiosulphate | as per test |
| 59 | (I-2) | tetramethylammonium thiocyanate | as per test |
| 60 | (I-2) | tetramethylammonium citrate | as per test |
| 61 | (I-2) | tetramethylammonium oxalate | as per test |
| 62 | (I-2) | tetramethylammonium formate | as per test |
| 63 | (I-2) | tetramethylammonium | as per test |
| | | hydrogenphosphate | |
| 64 | (I-2) | tetramethylammonium | as per test |
| | | dihydrogenphosphate | |
| 65 | (I-2) | tetraethylammonium sulphate | as per test |
| 66 | (I-2) | tetraethylammonium lactate | as per test |
| 67 | (I-2) | tetraethylammonium nitrate | as per test |
| 68 | (I-2) | tetraethylammonium thiosulphate | as per test |
| 69 | (I-2) | tetraethylammonium thiocyanate | as per test |
| 70 | (I-2) | tetraethylammonium citrate | as per test |
| 71 | (I-2) | tetraethylammonium oxalate | as per test |
| 72 | (I-2) | tetraethylammonium formate | as per test |
| 73 | (I-2) | tetraethylammonium | as per test |
| | | hydrogenphosphate | |
| 74 | (I-2) | tetraethylammonium | as per test |
| | | dihydrogenphosphate | |
| 75 | (I-3) | ammonium sulphate | as per test |
| 76 | (I-3) | ammonium lactate | as per test |
| 77 | (I-3) | ammonium nitrate | as per test |
| 78 | (I-3) | ammonium thiosulphate | as per test |
| 79 | (I-3) | ammonium thiocyanate | as per test |
| 80 | (I-3) | ammonium citrate | as per test |
| 81 | (I-3) | ammonium oxalate | as per test |
| 82 | (I-3) | ammonium formate | as per test |
| 83 | (I-3) | ammonium hydrogenphosphate | as per test |
| 84 | (I-3) | ammonium dihydrogenphosphate | as per test |
| 85 | (I-3) | ammonium carbonate | as per test |
| 86 | (I-3) | ammonium benzoate | as per test |
| 87 | (I-3) | ammonium sulphite | as per test |
| 88 | (I-3) | ammonium benzoate | as per test |
| 89 | (I-3) | ammonium hydrogenoxalate | as per test |
| 90 | (I-3) | ammonium hydrogencitrate | as per test |
| 91 | (I-3) | ammonium acetate | as per test |
| 92 | (I-3) | tetramethylammonium sulphate | as per test |
| 93 | (I-3) | tetramethylammonium lactate | as per test |
| 94 | (I-3) | tetramethylammonium nitrate | as per test |
| 95 | (I-3) | tetramethylammonium thiosulphate | as per test |
| 96 | (I-3) | tetramethylammonium thiocyanate | as per test |
| 97 | (I-3) | tetramethylammonium citrate | as per test |
| 98 | (I-3) | tetramethylammonium oxalate | as per test |
| 99 | (I-3) | tetramethylammonium formate | as per test |
| 100 | (I-3) | tetramethylammonium | as per test |
| | | hydrogenphosphate | |
| 101 | (I-3) | tetramethylammonium | as per test |
| | | dihydrogenphosphate | |
| 102 | (I-3) | tetraethylammonium sulphate | as per test |
| 103 | (I-3) | tetraethylammonium lactate | as per test |
| 104 | (I-3) | tetraethylammonium nitrate | as per test |
| 105 | (I-3) | tetraethylammonium thiosulphate | as per test |
| 106 | (I-3) | tetraethylammonium thiocyanate | as per test |
| 107 | (I-3) | tetraethylammonium citrate | as per test |
| 108 | (I-3) | tetraethylammonium oxalate | as per test |
| 109 | (I-3) | tetraethylammonium formate | as per test |
| 110 | (I-3) | tetraethylammonium | as per test |
| | | hydrogenphosphate | |
| 111 | (I-3) | tetraethylammonium | as per test |
| | | dihydrogenphosphate | |

Crop protection compositions according to the invention may also comprise further components, for example, surfactants and/or dispersing auxiliaries or emulsifiers.

Suitable nonionic surfactants and/or dispersing auxiliaries include all substances of this type that can usually be used in agrochemical compositions. Polyethylene oxide/polypropylene oxide block copolymers, polyethylene glycol ethers of straight-chain alcohols, reaction products of fatty acids with ethylene oxide and/or propylene oxide, furthermore polyvinyl alcohol, polyvinyl pyrrolidone, copolymers of polyvinyl alcohol and polyvinyl pyrrolidone and copolymers of (meth)acrylic acid and (meth)acrylic esters, and additionally alkyl ethoxylates and alkylaryl ethoxylates, which optionally may be phosphated and optionally may be neutralized with bases, examples of which that may be mentioned being sorbitol ethoxylates, and also polyoxyalkyleneamine derivatives may be mentioned as being preferred.

Suitable anionic surfactants are all substances of this type that can usually be used in agrochemical compositions. Preference is given to alkali metal salts and alkaline earth metal salts of alkylsulphonic acids or alkylarylsulphonic acids.

A further preferred group of anionic surfactants and/or dispersing auxiliaries are the following salts that are of low solubility in plant oil: salts of polystyrenesulphonic acids, salts of polyvinylsulphonic acids, salts of naphthalenesulphonic acid/formaldehyde condensation products, salts of condensation products of naphthalenesulphonic acid, phenolsulphonic acid and formaldehyde, and salts of lignosulphonic acid.

Suitable additives which may be included in the formulations according to the invention are emulsifiers, foam inhibitors, preservatives, antioxidants, colorants and inert filling materials.

Preferred emulsifiers are ethoxylated nonylphenols, reaction products of alkylphenols with ethylene oxide and/or propylene oxide, ethoxylated arylalkylphenols, and also ethoxylated and propoxylated arylalkylphenols, and also sulphated or phosphated arylalkyl ethoxylates and/or arylalkyl ethoxypropoxylates, mention being made by way of example of sorbitan derivatives, such as polyethylene oxide sorbitan fatty acid esters and sorbitan fatty acid esters.

1. Composition comprising
at least one phthalic acid diamide of formula (I) 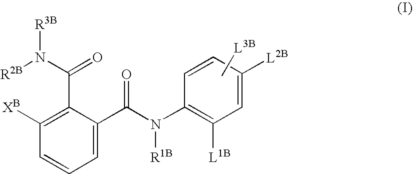
in which
X^{B} represents halogen, cyano, C₁-C₈-alkyl, C₁-C₈-haloalkyl, C₁-C₈-alkoxy or C₁-C₈-haloalkoxy,
R^{1B}, R^{2B} and R^{3B} independently of one another represent hydrogen, cyano, optionally halogen-substituted C₃-C₈-cycloalkyl or the group -M^{1B}-Q^{B}ₖ,
M^{1B} represents optionally substituted achiral C₁-C₁₂-alkylene, achiral C₃-C₁₂-alkenylene or achiral C₃-C₁₂-alkynylene,
Q^{B} represents hydrogen, halogen, cyano, nitro, C₁-C₈-haloalkyl, in each case optionally substituted C₃-C₈-cycloalkyl, C₁-C₈-alkyl-carbonyl or C₁-C₈-alkoxy-carbonyl, in each case optionally substituted phenyl, hetaryl or represents the group -T^{B}-R^{4B},
T^{B} represents oxygen, —S(O)ₘ— or —N(R^{5B})—,
R^{4B} represents hydrogen, in each case optionally substituted C₁-C₁₂-alkyl, C₃-C₁₂-alkenyl, C₃-C₁₂-alkynyl, C₃-C₈-cycloalkyl, C₃-C₈-cycloalkyl-C₁-C₆-alkyl, C₁-C₆-alkoxy-C₁-C₄-alkyl, C₁-C₈-alkyl-carbonyl, C₁-C₈-alkoxy-carbonyl, phenyl, phenyl-C₁-C₄-alkyl, phenyl-C₁-C₄-alkoxy, hetaryl, or hetaryl-C₁-C₄-alkyl,
R^{5B} represents hydrogen, in each case optionally substituted C₁-C₈-alkyl-carbonyl, C₁-C₈-alkoxy-carbonyl, phenylcarbonyl or phenyl-C₁-C₆-alkoxy-carbonyl,
k represents 1, 2, 3, or 4,
m represents 0, 1 or 2,
R^{1B} and R^{2B} together may form an optionally substituted 4- to 7-membered ring which may optionally be interrupted by heteroatoms,
L^{1B} and L^{3B} independently of one another represent hydrogen, halogen, cyano or in each case optionally substituted C₁-C₈-alkyl, C₁-C₈-alkoxy, C₁-C₆-alkyl-S(O)ₘ—, phenyl, phenoxy or hetaryloxy,
L^{2B} represents hydrogen, halogen, cyano, in each case optionally substituted C₁-C₁₂-alkyl, C₂-C₁₂-alkenyl, C₂-C₁₂-alkynyl, C₁-C₁₂-haloalkyl, C₃-C₈-cycloalkyl, phenyl, hetaryl or represents the group -M^{2B}-R^{6B},
M^{2B} represents oxygen or —S(O)ₘ—,
R^{6B} represents in each case optionally substituted C₁-C₈-alkyl, C₂-C₈-alkenyl, C₃-C₆-alkynyl, C₃-C₈-cycloalkyl, phenyl or hetaryl,
L^{1B} and L^{3B} or L^{1B} and L^{2B} in each case together form an optionally substituted 5- or 6-membered ring which may optionally be interrupted by heteroatoms,
and
at least one salt of the formula (II) 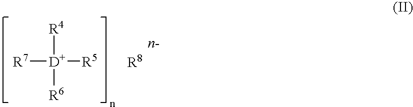
in which
D represents nitrogen or phosphorus,
R⁴, R⁵, R⁶ and R⁷ independently of one another represent hydrogen or in each case optionally substituted C₁-C₈-alkyl or mono- or polyunsaturated, optionally substituted C₁-C₈-alkylene, where the substituents may be selected from the group consisting of halogen, nitro and cyano,
n represents 1, 2, 3 or 4,
R⁸ represents an inorganic or organic anion.

2. Composition according to claim 1, wherein the total content of one or more phthalic acid diamides of the formula (I) is from 0.5 to 50% by weight.

3. Composition according to claim 1 wherein D represents nitrogen.

4. Composition according to claim 3, wherein R⁸ represents bicarbonate, tetraborate, fluoride, bromide, iodide, chloride, monohydrogenphosphate, dihydrogenphosphate, hydrogensulphate, tartrate, sulphate, nitrate, thiosulphate, thiocyanate, formate, lactate, acetate, propionate, butyrate, pentanoate, citrate or oxalate.

5. Composition according to claim 3, wherein R⁸ represents carbonate, pentaborate, sulphite, benzoate, hydrogenoxalate, hydrogencitrate, methylsulphate or tetrafluoroborate.

6. Composition according to claim 1 to further comprising at least one penetrant.

7. Composition according to claim 6, wherein the penetrant is (i) a fatty alcohol alkoxylate of formula (III)
R—O-(-AO)ᵥ—R′ (III)
in which
R represents straight-chain or branched alkyl having 4 to 20 carbon atoms,
R′ represents hydrogen, methyl, ethyl, n-propyl, isopropyl, n-butyl, isobutyl, t-butyl, n-pentyl or n-hexyl,
AO represents an ethylene oxide radical, a propylene oxide radical, a butylene oxide radical or represents a mixture of ethylene oxide and a propylene oxide radical or butylene oxide radical and
v represents a number from 2 to 30,
or (ii) a mineral or vegetable oil and/or (iii) an ester of a mineral or vegetable oil.

8. Composition according to claim 6, wherein the penetrant is an ester of a vegetable oil.

9. Composition according to claim 6, wherein the penetrant is rapeseed oil methyl ester.

10. Composition according to claim 6 wherein the penetrant is present in an amount from 1 to 95% by weight.

11. Method of controlling harmful insects comprising applying, a composition according to claim 1 neat or diluted to an insect or a habitat of an insect in such an amount that an effective amount of the insecticidally active compounds contained therein acts on the insect or habitat.

12. A ready-to-use spray liquor composition capable of increasing activity of crop protection of a phthalic acid diamide comprising a composition according to claim 1.

13. Method according to claim 12, wherein the spray liquor composition further comprises a penetrant.

14. Method according to claim 12 wherein the salt of the formula (II) is present in said composition in a concentration of from 0.5 to 80 mmol/l.

15. Method according to claim 13, wherein the penetrant in said composition is present in a concentration of from 0.1 to 10 g/l.

16. Method according to claim 15, wherein the penetrant is present in said composition in a concentration of from 0.1 to 10 g/l and the salt of the formula (II) is present in a concentration of from 0.5 to 80 mmol/l.

17. A method for increasing the activity of a crop protection composition comprising phthalic acid diamide active compound comprising utilizing a composition according to claim 1 wherein inclusion of said salt of formula (II) in preparing a ready-to-use crop protection spray liquor composition is capable of increasing activity of crop protection of said phthalic acid diamide.

18. A method according to claim 17, wherein the salt of the formula (II) is present in the ready-to-use crop protection composition in a concentration of from 0.5 to 80 mmol/l.

19. A method according to claim 17 wherein the ready-to-use crop protection composition further comprises a penetrant.
